(19) United States
(12) Patent Application Publication
(10) Pub. No.: US 2005/0138014 A1
(43) Pub. Date: Jun. 23, 2005

(54) System and method for visualization of mainframe change management metadata

(75) Inventors: Sapan Bhasker, Westford, MA (US); Susan Cohan, Needham, MA (US); Peter G. McCullough, Southborough, MA (US)

Correspondence Address: CALFEE, HALTER & GRISWOLD, LLP, 1110 FIFTH THIRD CENTER, 21 EAST STATE STREET, COLUMBUS, OH, 43215-4243, US

(73) Assignee: Computer Associates Think, Inc.

(21) Appl. No.: 10/888,265

(22) Filed: Jul. 9, 2004

Related U.S. Application Data
(60) Provisional application No. 60/487,061, filed on Jul. 11, 2003.

(51) Int. Cl. G06F 7/00

(52) U.S. Cl. 707/3

(57) ABSTRACT

Methods, systems, apparatus and computer-readable media are disclosed for providing cross-platform software dependency information. A first example method is disclosed for providing metadata information for display in a graphical format. The method includes the step of receiving from a web browser a request for information relating to a platform-specific application. The method also includes transmitting to the platform-specific application, a request for metadata representing the requested information, and receiving metadata from the platform-specific application. The method further includes combining the metadata with viewing instructions for creating a graphical representation of the metadata, and transmitting the combined metadata and viewing instructions to the user for presentation. Other methods, apparatus, systems and computer readable media are disclosed for presenting metadata in a graphical format.

### CROSS REFERENCE TO RELATED APPLICATIONS

This application claims priority to and incorporates by reference the entirety of U.S. provisional application entitled “System and Method for Visualization of Metadata,” Ser. No. 60/487,061, filed Jul. 11, 2003.

### TECHNICAL FIELD

The described systems and methods are generally related to information processing environments in which metadata is presented in a graphical format to a user. More specifically, the described systems and methods are related to graphically presenting metadata received from a one or more platform-specific applications.

### BACKGROUND

Enterprises often employ large, complex, computing environments that include a number of enterprise components such as servers, routers, databases, repositories, mainframes, personal computers, business applications and enterprise management software, for example. Such enterprises may have a desire to enable access to data from one or more platform-specific applications on one or more platforms through a single interface.

One example of an area in which such a desire may arise is with regard to impact analysis applications, applications which evaluate what software modules will change if a proposed change is made to a particular software module. Certain prior art impact analysis tools, commonly referred to as change and configuration management (“CCM”) applications, are available to assist in analyzing dependencies of software modules. Two such example CCM applications are known as “AllFusion Endevor Change Manager” and “AllFusion Harvest Change Manager”, each of which is developed, manufactured and marketed by Computer Associates (“CA”), the assignee of the present application.

These and other prior art impact analysis tools are designed to provide software module dependency information for software modules supported by a specific platform, such as Windows, UNIX or a mainframe platform, for example. Consequently, an enterprise supporting multiple platforms is presently unable to automatically obtain a comprehensive or integrated analysis of software dependencies across platforms. Presently, such a cross-platform impact analysis entails obtaining a separate dependency analysis for each platform and combining the analyses using one or more other software tools, such as a spreadsheet, database and report generation applications. The difficulties in assessing and analyzing the impact of proposed software changes is further complicated by the distributed nature of web-based software applications.

Consequently, there is a need for methods and systems that address the shortcomings of prior art platform-specific applications and provide integrated graphical visualization of metadata received from on different platforms. A need exists for methods and systems to present data to users who may be unfamiliar with the user interface of a platform-specific application. More specifically, there is a need to enable visualization of cross-platform information in the form of bar graphs, pie charts and other reports, from both distributed and mainframe applications.

### SUMMARY

The following presents a simplified summary of methods, apparatus, systems, and computer readable media associated with graphically presenting change and configuration management information in accordance with the present application. This summary is not an extensive overview and is not intended to identify key or critical elements of the methods, apparatus, systems, and/or media or to delineate the scope of the methods, apparatus, systems, and media. It conceptually identifies the methods, apparatus, systems, and media in a simplified form as a prelude to the more detailed description that is presented later.

In accordance with one aspect of the present application, an example method is disclosed for providing metadata information for display in a graphical format. The method includes the step of receiving from a web browser a request for information relating to a platform-specific application. The method also includes transmitting to the platform-specific application, a request for metadata representing the requested information, and receiving metadata from the platform-specific application. The method further includes combining the metadata with viewing instructions for creating a graphical representation of the metadata, and transmitting the combined metadata and viewing instructions to the user for presentation

In accordance with a second aspect of the present application, an example system is disclosed for presenting metadata information in a graphical format. The system includes a web browser client and a graphical viewer in communication with the web browser client. The graphical viewer is operative to display metadata information based on received viewing instructions. The system also includes a platform-specific application operative to respond to a query with metadata information. The system further includes a server application in communication with the web browser client and the platform-specific application. The server application is operative to receive from the web browser a request for platform-specific metadata information. The server application queries the platform-specific application, receives metadata from the platform-specific application, combines the received metadata information with viewing instructions, and transmits the combined metadata and viewing instructions to the web browser for display. The web browser and graphical viewer cooperate to process the combined metadata and viewing instructions to present the metadata information in a graphical format.

In accordance with a third aspect of the present application, an example apparatus is disclosed for presenting metadata information in a graphical format. The apparatus includes a processor and a memory in communication with the processor. The memory stores a program to control the operation of the processor. The processor is operative with the program in the memory to receive from a web browser a request for information relating to a platform-specific application.

The processor is also operative with the program in the memory to transmit to the platform-specific application, a request for metadata representing the requested information, and receive metadata from the platform-specific application. The processor is further operative with the program in the memory to combine the metadata with viewing instructions for creating a graphical representation of the metadata, and transmit the combined metadata and viewing instructions to the user for presentation.

In accordance with a third aspect of the present application, an example computer-readable storage medium is disclosed. The medium is encoded with processing instructions for presenting metadata information in a graphical format.

Certain illustrative aspects of the methods, apparatus, systems and computer-readable media are described herein in connection with the following description and the annexed drawings. These aspects are indicative, however, of but a few of the various ways in which the principles of the methods, apparatus, systems, and media may be employed and thus the examples are intended to include such aspects and equivalents. Other advantages and novel features may become apparent from the following detailed description when considered in conjunction with the drawings.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1 is a block diagram illustrating an example enterprise information processing environment, in accordance with the systems and methods described in the present application;

FIG. 2 is a block diagram illustrating a more detailed view of certain components of the example enterprise information processing environment of FIG. 1; and

FIG. 3 is an example methodology for presenting CCM information in an integrated display.

### DETAILED DESCRIPTION

Example methods and systems are now described with reference to the drawings, where like reference numerals are used to refer to like elements throughout. In the following description, for purposes of explanation, numerous specific details are set forth in order to facilitate thoroughly understanding the methods and systems. It may be evident, however, that the methods and systems can be practiced without these specific details. In other instances, well-known structures and devices are shown in block diagram form in order to simplify the description.

The present application relates to and incorporates by reference the entirety of two U.S. provisional patent applications entitled “System and Method for Graphically Presenting Change and Configuration Management Information,” Ser. No. 60/487,060, and U.S. provisional patent application entitled “System and Method for Displaying Impact Analysis Data”, Ser. No. 60/487,063, each filed Jul. 11, 2003. The present application also relates to and incorporates by reference the entirety of two concurrently filed U.S. non-provisional patent applications entitled “System and Method for Graphically Presenting Change and Configuration Management Information” and “System and Method for Displaying Impact Analysis Data,” each incorporated by reference in its entirety.

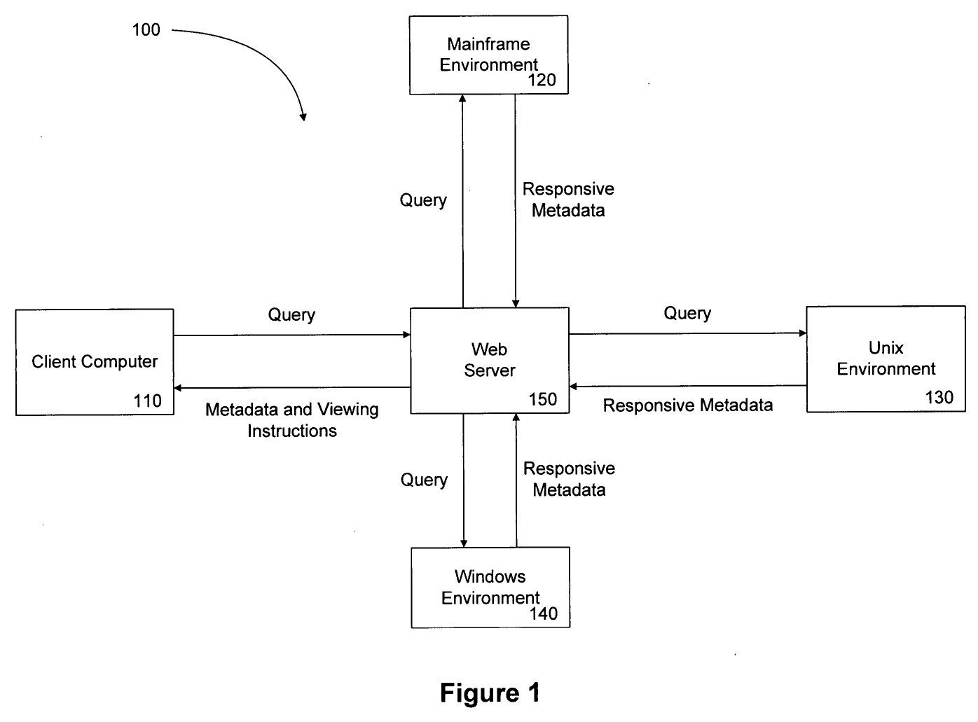

Referring to FIG. 1, a schematic block diagram illustrates an example enterprise information processing environment 100, and associated data flow within the example environment. The example enterprise environment 100 includes a client computer 110 that is in communication with a web server 150. Among the data that may be communicated between computer 110 and web server 150, computer 110 transmits to web server 150 a request for metadata to be graphically represented at computer 110. In response, after obtaining the requested metadata and combining it with viewing instructions, as described in greater detail below, web server 150 transmits the requested metadata and appropriate viewing instructions back to computer 110.

The web server 150 is also in communication with at least one platform-specific environment. Three such platform-specific environments are illustrated in the example enterprise 100. In the illustrated example, web server 150 is in communication with mainframe environment 120, UNIX environment 130 and Windows environment 140. Of course, web server 150 may also be in communication with other platform-specific environments not illustrated in FIG. 1, such as Apple and Linux, for example. Upon receiving a user's request for metadata information from computer 110, web server 150 transmits a platform-specific query to one or more of the environments 120, 130 and 140, to obtain the requested metadata related to the user's query. Each platform 120, 130 and 140, through a local application, responds to web server 150 by transmitting responsive metadata.

According to the example enterprise environment 100, a user employs computer 110, to request the metadata using a single query. The present methods and systems allow users to access data on distributed platforms without requiring knowledge of the specific user interface for the responding application. Although processing of the query is distributed among several components of the enterprise 100, a display of metadata information is presented at a single point of control, namely computer 110.

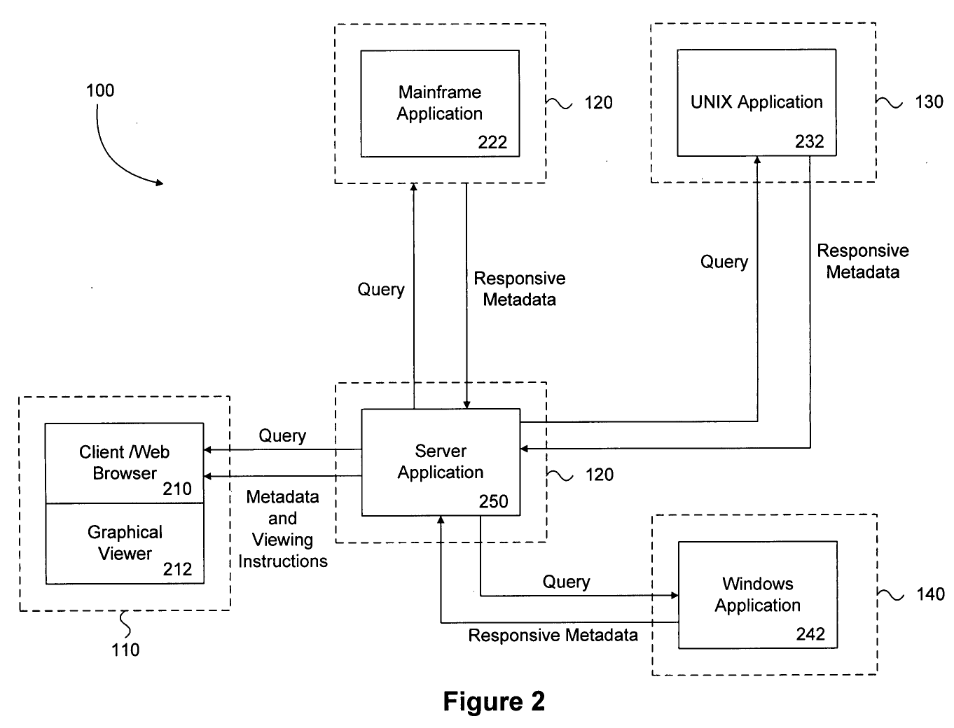

Referring now to FIG. 2, a schematic block diagram illustrates in more detail the example enterprise environment 100 illustrated in FIG. 1. Specifically, client computer 110 includes a web browser application 210 and a graphical viewer 212. In the illustrated example embodiment, the graphical viewer 212 is an application that is embedded or integrated within the web browser 210.

Web browser 210 of computer 110 communicates with server application 250 of web server 150. Specifically, web browser 210 transmits a query for metadata and viewing instructions to web server 150. The query is processed by server application 250 which provides an integrated, centralized point of control for platform-specific applications on mainframe 120 and distributed platforms 130 and 140.

As shown, web browser 210 requests the metadata and viewing instructions from server application 250, and server application 250 services the request, in part, by providing, for example, web pages, applications and applets, as well as metadata obtained from sources within the mainframe environment 120, UNIX environment 130 or Windows environment 140, such as, for example, mainframe application 222, UNIX application 232 and Windows application 242, respectively. The display instructions may include instructions to obtain additional information from the mainframe 120 or one of the distributed platforms 130 and 140.

In one example embodiment, web browser 210 is a conventional web browser, such as Microsoft Internet Explorer 6.0 or Netscape 7.1, for example, that supports plug-ins or other integrated applications. The embedded graphical viewer 212 includes the ability to collect and combine data from several data sources, including relational databases, multi-dimensional data sources, or flat files, for example, and present the combined data in a single location. In one example embodiment, the graphical viewer 212 could be “Cleverpath Forest & Trees” which is developed, manufactured and marketed by Computer Associates, the assignee of the present application. Cleverpath Forest & Trees can be installed as a runtime application, which can run within a web browser, and may be used to provide visualization of CCM information.

In the example embodiment, the server application 250 is a thin-client web-based application that uses JSP and Java technologies on the web server to generate dynamic HTML web pages, such as AllFusion CM Enterprise Workbench, provided by Computer Associates, for example. A Forest & Trees developer product may be used to develop the Forest & Trees graphical view files that can display the integrated CCM information at computer 110 from both mainframe and distributed platforms. Such graphical view files may be integrated into JSP web pages that are stored in a related database (not shown) as part of the AllFusion CM Enterprise Workbench product. A copy of the Forest & Trees runtime installation executable may be installed on the AllFusion CM Enterprise Workbench server and may be automatically downloaded and installed on the user's computer when the user loads a web page containing a Forest & Trees graphical view file for the first time. Subsequently, the downloaded Forest & Trees runtime application 212 is executed whenever the user loads a web page containing a link to a Forest & Trees graphical view file.

Server application 250 processes the user query and provides a query to accessible platform-specific CCM applications 222, such as CA's AllFusion Endevor CCM on mainframe 120. The platform-specific CCM application 222 responds with a query result including impact analysis metadata relating to the software supported by the platform. The server application 250 may combine the received metadata with metadata obtained from other platform-specific CCM applications and provides the processed query result to client web browser 210 for presentation to the user. In one embodiment, the combined query results may be presented to the user via a web page that contains an Forest & Trees graphical view file.

In order to access the CCM information from the AllFusion Endevor CM on Mainframe 120, Java programs on the AllFusion CM Enterprise Workbench server 250 make a call to the Endevor API on the Mainframe 120 and download the resulting CCM information from AllFusion Endevor CM 222 on the mainframe to the workstation. The Forest & Trees runtime application 212 in the web page on the user machine can then access the AllFusion Endevor CCM information on a workstation and display it graphically.

Access is similarly provided to the CCM information from the AllFusion Harvest CM on UNIX 230 and Windows 240, the web browser 210 and/or the Forest & Trees runtime application 212 in the web page on the user computer 110 can utilize server application 250, to request metadata from the appropriate platform-specific appilcation, such as AllFusion CM Harvest 232 and/or AllFusion CM Harvest 242. Respective databases may be maintained by CCM applications 232 and 242.

Server application 250 returns the resulting information to the Forest & Trees Runtime application 212 for presentation to the user. The combined information from the CCM products on Mainframe, Unix and Windows platforms can be integrated and presented to the user graphically in the form of bar graphs, pie charts and other reports

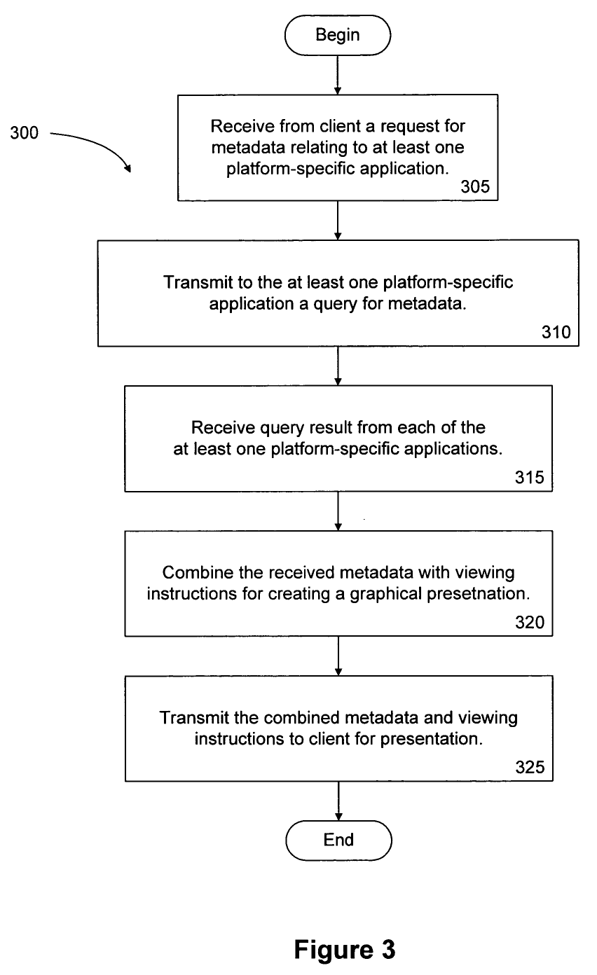

FIG. 3 is a flowchart illustrating an example method 300 for providing metadata information for display in a graphical format. At block 305, a request for metadata relating to at least one platform-specific application is received from a web browser, such as browser 220, for example, by a server application, such as server application 250. A query to each relevant platform-specific application is transmitted at block 310.

At block 315, metadata from each of the relevant platform-specific applications is received by the server application, and the metadata results are combined with viewing instructions for creating a graphical representation of the results, as shown by block 320. The server application transmits the combined metadata and viewing instructions back to the web browser for presentation. As described, the web browser may employ a graphical viewer to render the graphical representations of the metadata. Further, the graphical viewer could be a plug-in which is initially provided by the server application upon the first request for such graphically presented metadata.

What has been described above includes several examples. It is, of course, not possible to describe every conceivable combination of components or methodologies for purposes of describing the systems, apparatus, methods, and computer readable media associated with visualization of mainframe change management metadata. However, one of ordinary skill in the art may recognize that further combinations and permutations are possible. Accordingly, this application is intended to embrace such alterations, modifications, and variations that fall within the scope of the appended claims. Furthermore, to the extent that the term “includes” is employed in the detailed description or the claims, such term is intended to be inclusive in a manner similar to the term “comprising” as that term is interpreted when employed as a transitional word in a claim.

1. A method for providing metadata information for display in a graphical format, comprising:
receiving from a web browser a request for information relating to a platform-specific application;
transmitting to the platform-specific application, a request for metadata representing the requested information;
receiving metadata from the platform-specific application;
combining the metadata with viewing instructions for creating a graphical representation of the metadata; and
transmitting the combined metadata and viewing instructions to the user for presentation.

2. The method of claim 1, wherein the step of transmitting the combined metadata and viewing instructions in an HTML document.

3. The method of claim 1, further including combining the metadata and viewing information with metadata received from a second application-specific application.

4. A system for presenting metadata information in a graphical format, comprising:
a web browser client;
a graphical viewer in communication with the web browser client, the graphical viewer operative to display metadata information based on viewing instructions;
a platform-specific application operative to respond to a query with metadata information;
a server application in communication with the web browser client and the platform-specific application, the server application operative to receive from the web browser a request for platform-specific metadata information, query the platform-specific application, receive metadata from the platform-specific application, combine the received metadata information with viewing instructions, and transmit the combined metadata and viewing instructions to the web browser for display; and
the web browser and graphical viewer operative to process the combined metadata and viewing instructions to present the metadata information in a graphical format.

5. The system of claim 4, wherein the server application provides the web browser client with metadata and viewing instructions in an HTML document.

6. The system of claim 4, further including a second application-specific application, and wherein the server application is operative to combine the metadata received from the platform-specific application with metadata received from the second platform-specific application.

7. An apparatus for presenting metadata information in a graphical format, comprising:
a processor;
a memory connected to said processor storing a program to control the operation of said processor;
the processor operative with the program in the memory to:
receive from a web browser a request for information relating to a platform-specific application;
transmit to the platform-specific application, a request for metadata representing the requested information;
receive metadata from the platform-specific application;
combine the metadata with viewing instructions for creating a graphical representation of the metadata; and
transmitting the combined metadata and viewing instructions to the user for presentation.

8. The apparatus of claim 7, wherein the processor is further operative with the program in the memory to transmit the combined metadata and viewing instructions in an HTML document.

9. The apparatus of claim 7, wherein the processor is further operative with the program in the memory to combine the metadata and viewing information with metadata received from a second application-specific application.

10. A computer-readable storage medium encoded with processing instructions for presenting metadata information in a graphical format, the processing instructions for directing a computer to perform the steps of:
receiving from a web browser a request for information relating to a platform-specific application;
transmitting to the platform-specific application, a request for metadata representing the requested information;
receiving metadata from the platform-specific application;
combining the metadata with viewing instructions for creating a graphical representation of the metadata; and
transmitting the combined metadata and viewing instructions to the user for presentation.
